(19) United States
(12) Patent Application Publication
(10) Pub. No.: US 2024/0365753 A1
(43) Pub. Date: Nov. 7, 2024

(54) Retractable Leash Tether Assembly

(71) Applicants: Christopher Burkard, Kerrville, TX (US); Gloria Burkard, Kerrville, TX (US)

(72) Inventors: Christopher Burkard, Kerrville, TX (US); Gloria Burkard, Kerrville, TX (US)

(21) Appl. No.: 18/142,642

(22) Filed: May 3, 2023

(51) Int. Cl. A01K 27/00; A45F 5/00

(52) U.S. Cl. CPC A01K 27/004; A45F 5/00; A45F 2005/002; A45F 2005/006

(57) ABSTRACT

A retractable leash tether assembly includes a retractable animal leash that can be attached to a domesticated animal. A tether is included that has a first loop which is formed into the tether which can be positioned around the user's wrist. The tether has a leash attachment element facilitating the tether to be removably attached to the retractable animal leash. In this way the tether facilitates the user to keep control of the domesticated animal when the user loses grip of the retractable animal leash. The tether is comprised of an elastomeric material to inhibit the user's wrist from being injured due to the domesticated animal running from the user when the user loses grip of the grip.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to leash tether devices and more particularly pertains to a new leash tether device for inhibiting a user from losing control of a domesticated animal on a retractable animal leash. The device includes a retractable animal leash, a tether, a first adjustment slide disposed on the tether and a second adjustment slide disposed on the tether. The tether is looped through the first adjustment slide to form a first loop which can be placed around the user's wrist. The tether can be wrapped around the grip of the retractable animal leash and subsequently extended through the second adjustment slide to form a closed loop around the grip of the retractable animal leash.

### (2) Description of Related Art Including Information Disclosed Under 37 CFR 1.97 and 1.98

The prior art relates to leash tether devices including a variety of animal leash tethers that are attachable between a user's wrist and a retractable animal leash. In each circumstance the tether is releasably matable to itself to form a closed loop around either the user's wrist or a grip of the retractable animal leash. In no instance does the prior art discloses an elastomeric tether that has a first adjustment slide and a second adjustment slide for forming a pair of loops of an adjustable diameter in the tether which can be wrapped around the user's wrist and a grip of a retractable animal leash.

### BRIEF SUMMARY OF THE INVENTION

An embodiment of the disclosure meets the needs presented above by generally comprising a retractable animal leash that can be attached to a domesticated animal. A tether is included that has a first loop which is formed into the tether which can be positioned around the user's wrist. The tether has a leash attachment element facilitating the tether to be removably attached to the retractable animal leash. In this way the tether facilitates the user to keep control of the domesticated animal when the user loses grip of the retractable animal leash. The tether is comprised of an elastomeric material to inhibit the user's wrist from being injured due to the domesticated animal running from the user when the user loses grip of the grip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a retractable leash tether assembly according to an embodiment of the disclosure.

FIG. 2 is a perspective view of a tether of an embodiment of the disclosure.

FIG. 3 is a perspective in-use view of an embodiment of the disclosure.

### DETAILED DESCRIPTION OF THE INVENTION

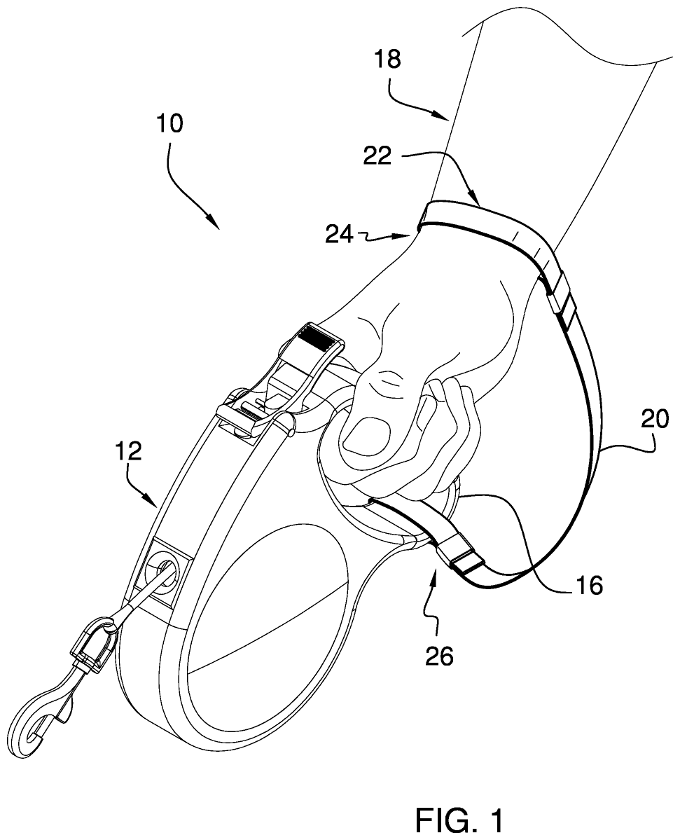

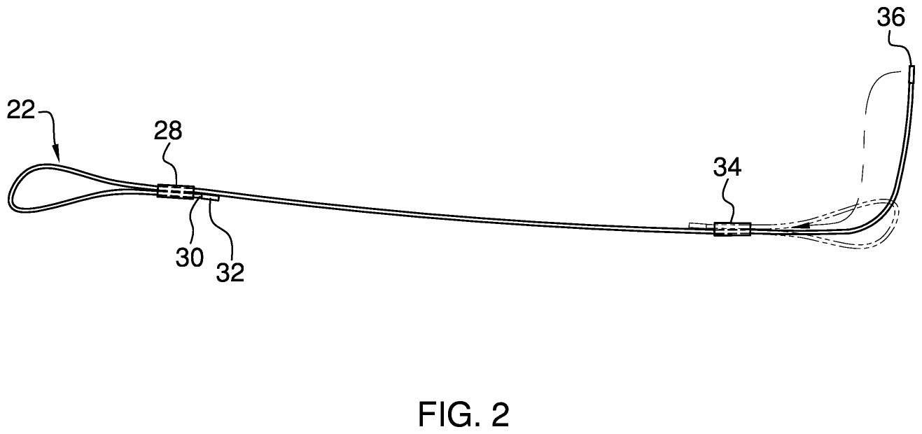

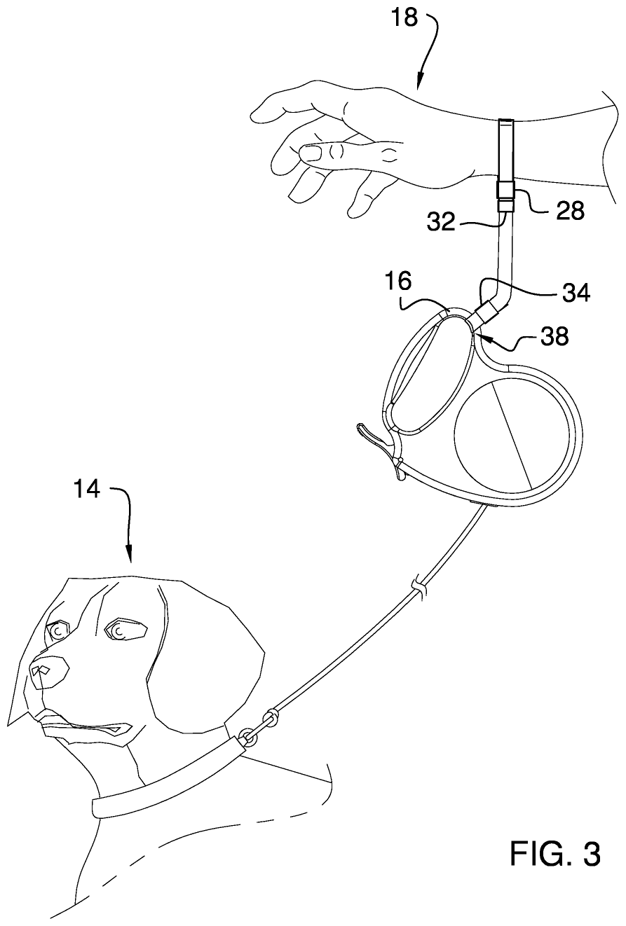

With reference now to the drawings, and in particular to FIGS. 1 through 3 thereof, a new leash tether device embodying the principles and concepts of an embodiment of the disclosure and generally designated by the reference numeral 10 will be described.

As best illustrated in FIGS. 1 through 3, the retractable leash tether assembly 10 generally comprises a retractable animal leash 12 that can be attached to a domesticated animal 14. The retractable animal leash 12 has a grip 16 that can be gripped by a user 18 that is walking the domesticated animal 14. The domesticated animal 14 may be a dog or other animal commonly kept as a pet. A tether 20 is included which has a first loop 22 that is formed into the tether 20 such that the first loop 22 can be positioned around the user's wrist 24. The tether 20 has a leash attachment element 26 facilitating the tether 20 to be removably attached to the retractable animal leash 12. In this way the tether 20 facilitates the user 18 to keep control of the domesticated animal 14 when the user 18 loses grip of the retractable animal leash 12. Furthermore, the tether 20 is comprised of an elastomeric material to inhibit the user's wrist 24 from being injured due to the domesticated animal 14 running from the user 18 when the user 18 loses grip of the grip 16.

A first adjustment slide 28 is formed into a closed loop and the tether 20 extends through the first adjustment slide 28. The tether 20 is looped through the first adjustment slide 28 having a first end 30 of the tether 20 passing through the first adjustment slide 28 thereby forming the first loop 22 in the tether 20. The first adjustment slide 28 is slidable along the tether 20 for adjusting a diameter of the first loop 22 to accommodate a variety of sizes of user's wrists. A stop 32 is integrated into the first end 30 of the tether 20 to inhibit the first end 30 of the tether 20 from being pulled through the first adjustment slide 28 thereby facilitating the first loop 22 to be permanently formed into the tether 20.

A second adjustment slide 34 is provided and the second adjustment slide 34 is formed into a closed loop. A second end 36 of the tether 20 is extendable through the second adjustment slide 34 when the tether 20 is wrapped around the grip 16 of the retractable animal leash 12. In this way a second loop 38 is formed in the tether 20 which extends around the grip 16 of the retractable animal leash 12. Furthermore, the second adjustment slide 34 and the second loop 38 define the leash attachment element 26.

In use, the user 18 extends one of their hands through the first loop 22 of the tether 20 such that the first loop 22 extends around the user's wrist 24. Additionally, the first adjustment slide 28 is manipulated to adjust the diameter of the first loop 22 to snugly fit around the user's wrist 24. The tether 20 is wrapped around the grip 16 of the retractable animal leash 12 and the second end 36 of the tether 20 is extended through the second adjustment slide 34 to form a closed loop around the grip 16 of the retractable animal leash 12. In this way the tether 20 ensures that the domesticated animal 14 will not run away from the user 18 in the event that the user 18 loses their grip on the retractable animal leash 12. Furthermore, the elastomeric quality of the tether 20 facilitates the tether 20 to stretch if the domesticated animal 14 begins to run away from the user 18 thereby inhibiting the user 18 from being injured by a sudden jerk on the user's wrist 24. In this way the user 18 can maintain continuous control of the domesticated animal 14 with minimal risk of injury.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A retractable leash tether assembly for attaching a retractable leash to a user's wrist thereby inhibiting a canine on the retractable leash from running away from the user, said assembly comprising:
a retractable animal leash being configured to be attached to a domesticated animal, said retractable animal leash having a grip being configured to be gripped by a user that is walking the domesticated animal; and
a tether having a first loop being formed into said tether wherein said first loop is configured to be positioned around the user's wrist, said tether having a leash attachment element facilitating said tether to be removably attached to said retractable animal leash wherein said tether is configured to facilitate the user to keep control of the domesticated animal when the user loses grip of said retractable animal leash, said tether being comprised of an elastomeric material wherein said tether is elastic and configured to inhibit the user's wrist from being injured due to the domesticated animal running from the user when the user loses grip of said grip.

2. The assembly according to claim 1, further comprising a first adjustment slide being formed into a closed loop, said tether extending through said first adjustment slide, said tether being looped through said first adjustment slide having a first end of said tether passing through said first adjustment slide thereby forming said first loop in said tether.

3. The assembly according to claim 2, wherein said first adjustment slide is slidable along said tether for adjusting a diameter of said first loop wherein said first loop is configured to accommodate a variety of sizes of user's wrists.

4. The assembly according to claim 2, further comprising a second adjustment slide being formed into a closed loop, said tether extending through said second adjustment slide, a second end of said tether being extendable through said second adjustment slide when said tether is wrapped around said grip of said retractable animal leash thereby forming a second loop in said tether which extends around said grip of said retractable animal leash.

5. The assembly according to claim 4, wherein said second adjustment slide and said second loop defines said leash attachment element.

6. A retractable leash tether assembly for attaching a retractable leash to a user's wrist thereby inhibiting a canine on the retractable leash from running away from the user, said assembly comprising:
a retractable animal leash being configured to be attached to a domesticated animal, said retractable animal leash having a grip being configured to be gripped by a user that is walking the domesticated animal; and
a tether having a first loop being formed into said tether wherein said first loop is configured to be positioned around the user's wrist, said tether having a leash attachment element facilitating said tether to be removably attached to said retractable animal leash wherein said tether is configured to facilitate the user to keep control of the domesticated animal when the user loses grip of said retractable animal leash, said tether being comprised of an elastomeric material wherein said tether is elastic and configured to inhibit the user's wrist from being injured due to the domesticated animal running from the user when the user loses grip of said grip;
a first adjustment slide being formed into a closed loop, said tether extending through said first adjustment slide, said tether being looped through said first adjustment slide having a first end of said tether passing through said first adjustment slide thereby forming said first loop in said tether, said first adjustment slide being slidable along said tether for adjusting a diameter of said first loop wherein said first loop is configured to accommodate a variety of sizes of user's wrists; and
a second adjustment slide being formed in to a closed loop, said tether extending through said second adjustment slide, a second end of said tether being extendable through said second adjustment slide when said tether is wrapped around said grip of said retractable animal leash thereby forming a second loop in said tether which extends around said grip of said retractable animal leash, said second adjustment slide and said second loop defining said leash attachment element.

7. A method of securing a retractable animal leash to a user's wrist, the steps of the method comprising:
positioning a first loop of a tether around a user's wrist, said tether being comprised of an elastomeric material wherein said tether is elastic;
pulling a first end of said tether through a first adjustment slide to tighten said first loop of said tether around the user's wrist;
wrapping said tether around a grip of a retractable animal leash; and
extending a second end of said tether through a second adjustment slide to form a second loop of said tether which extends around said grip of said retractable leash such that said tether inhibits the domesticated animal attached to said retractable animal leash from running away from the user.
